(19) United States
(12) Patent Application Publication
(10) Pub. No.: US 2023/0190031 A1
(43) Pub. Date: Jun. 22, 2023

(54) DISPENSER CARTRIDGE

(71) Applicant: Grohe AG, Hemer (DE)

(72) Inventors: Björn RIEDEL, Bochum (DE); Martin SCHNEIDER, Finnentrop (DE); Alisha SCHOLAND, Balve (DE)

(73) Assignee: Grohe AG, Hemer (DE)

(21) Appl. No.: 17/914,827

(22) PCT Filed: Mar. 2, 2021
(86) PCT No.: PCT/EP2021/055193

§ 371 Date: Feb. 9, 2023

(30) Foreign Application Priority Data
Mar. 27, 2020 (DE) 10 2020 108 554.0

(51) Int. Cl. A47J 31/40

(52) U.S. Cl. CPC A47J 31/407

(57) ABSTRACT

A dispenser cartridge (1) for a drinking-water dispensing system (2), by means of which at least partially carbonated drinking water can be discharged from an outlet element (3) of the drinking-water dispensing system (2), wherein the dispenser cartridge (1) is provided and set up for introducing a dispenser substance (4) into the drinking water, wherein the dispensing cartridge (1) comprises a mount (5) for an exchangeable dispensing capsule (6) comprising the dispenser substance (4), wherein the dispensing capsule (6) can be held in the mount (5) in such a manner that at least a part of the drinking water flows through or around at least a part of the dispensing capsule (6), and wherein the dispensing cartridge (1) is set up in such a manner that it can be detachably installed in the outlet element (3) of the drinking-water dispensing system (2).

This invention relates to a dispenser cartridge for a drinking-water dispensing system, a drinking-water dispensing system having such a dispenser cartridge, a method for dispensing at least partially carbonated drinking water, in which a dispenser substance is introduced inside an outlet element of a drinking-water dispensing system, and a use of a dispenser cartridge installed in an outlet element of a drinking-water dispensing system. In particular, the invention is used to enrich at least partially carbonated drinking water with a specific flavor.

Drinking water dispensers for discharging at least partially carbonated drinking water on demand are known. These usually have a water faucet and a carbonation device. The water faucet is often a kitchen faucet and/or sink faucet. The carbonation device is usually set up to enrich drinking water coming from a cold-water line with carbonic acid. The carbonated drinking water can then be routed from the carbonator to the water faucet. The carbonation device may further include a filter for improving the quality of the drinking water and/or a cooler for providing particularly cold drinking water. Within the water fixture, cold water and hot water can also be mixed so the water fixture can discharge mixed water at a water temperature desired by a user. The water faucet can mix the carbonated drinking water coming from the carbonation device with cold water or mixed water in order to be able to set a desired level of carbonation, which may be selected by a user. It was observed that for many users the mentioned choices for temperature and strength of carbonation of drinking water are still not sufficient. Instead, many users nowadays want to be able to customize their drinks as much as possible. At the same time, it should be possible to produce this beverage quickly and in as large a quantity as desired, if required.

Additives have already been proposed for the individualization of beverages, which the user can add manually to the drinking water. For instance, a wide variety of teas, powders, cubes, tablets and the like are known which the user can mix in a vessel with drinking water to flavor the latter.

Furthermore, many users nowadays also include pieces of fruit, herbs or other plant parts in vessels such as carafes or drinking bottles to flavor the drinking water stored therein accordingly. However, many of these preparation methods are difficult to perform with carbonated drinking water or may yield an unsatisfactory result, because the carbonic acid content in the drinking water decreases too much with the time usually required for flavoring. In addition, many users also consider the preparation time required in connection with the described preparation methods as too long. Furthermore, it is disadvantageous for many users that the preparation in one vessel usually always results in only a certain amount of the beverage.

Based thereon, this invention addresses the problem of at least partially solving the problems indicated with reference to the prior art. In particular, a dispenser cartridge for a drinking-water dispensing system, a drinking-water dispensing system with a corresponding dispenser cartridge, a method for dispensing at least partially carbonated drinking water, into which a dispenser substance is introduced inside an outlet element of a drinking-water dispensing system, and a use of a dispenser cartridge installed in an outlet element of a drinking-water dispensing system, which at least contribute to a user being able to design a beverage as individually as possible and at the same time being able to produce this beverage as quickly as possible and in the desired a quantity.

These problems are solved by the features of the independent claims. Further advantageous embodiments of the solution proposed here are specified in the dependent claims. It will be appreciated that the features listed individually in the dependent claims may be combined in any technologically useful manner and define further embodiments of the invention. In addition, the features indicated in the claims are further specified and explained in the description, wherein further preferred embodiments of the invention are illustrated.

A dispenser cartridge for a drinking-water dispensing system, by means of which at least partially carbonated drinking water can be discharged from an outlet element of the drinking-water dispensing system, contributes to solving the problem, wherein the dispenser cartridge is provided and set up for introducing a dispenser substance into the drinking water, wherein the dispensing cartridge comprises a mount for an exchangeable dispensing capsule comprising the dispenser substance, wherein the dispensing capsule can be held in the mount in such a manner that at least part of the drinking water flows through or around at least a part of the dispensing capsule, and wherein the dispensing cartridge is set up in such a manner that it can be detachably installed in the outlet element of the drinking-water dispensing system.

For instance, the dispenser cartridge may be designed to have an integrally formed cartridge body or one of multi-part design. For instance, the cartridge body may be metallic or formed using a plastic. The dispenser cartridge may be elongated in shape. In other words, this can also be described as the cartridge having a length that is at least two or three times greater than its (max.) diameter or width and/or depth. The dispenser cartridge can have a mechanical connection means, such as a (male) thread, at at least one end to be able to install the dispenser cartridge (as easily as possible) in the outlet element, in particular to screw it in. In particular, the dispenser cartridge can be completely installed in the outlet element or inserted in an outlet housing of the outlet element. In particular, the dispenser cartridge can be inserted (especially pushed) into the outlet element along its entire length. By way of example, the dispenser cartridge may be positioned (directly) upstream of a spray plate of the outlet element in the outlet element. Further, the dispensing cartridge may be disposed downstream of a connection point of the outlet element in the outlet element. The connection point relates in particular to the connection point, which can be used to connect the outlet element to a base element of a water faucet of the drinking-water dispensing system. The base element typically includes the valve components of the water fixture and can be typically mounted on a plate, such as a kitchen countertop and/or sink. Furthermore, the outlet element can be rotated relative to the base element of the water faucet. For this purpose, the outlet element can be rotatably mounted on the base element at the connection point, for instance. In particular, the dispenser cartridge can be arranged downstream of a bend or curve of the outlet element and/or in an end section (in the installed position) in the outlet element, which preferably points downward.

The dispenser substance may be, for instance, a plant-based substance and/or a fruit-based substance. The dispenser substance may, for instance, contain flavoring substances and/or colorants, in particular to introduce a specific flavor or color into the drinking water or to flavor, color or add the substance to the drinking water accordingly. The dispenser cartridge can be used to advantageously introduce the dispenser substance directly into the outlet of the drinking-water dispensing system, where it can be brought into contact with chilled, still or carbonated drinking water, for instance. The drinking water can in that way advantageously be flavored directly in the faucet or in the outlet, such that the finished flavored beverage is present when it leaves the outlet and is still advantageously cooled and/or carbonated. Furthermore, the aromatic beverage prepared in this way can advantageously be produced in as arbitrary a quantity as possible. The dispenser cartridge advantageously permits flavoring of carbonated water directly in the flow through the outlet element. The design of the mount advantageously permits the drinking water to flow past or through the dispenser substance as it flows through the outlet element, thus absorbing aromatic substances, for instance, in a particularly advantageous manner.

For instance, the dispensing capsule may be a capsule, container, or the like. In particular, the dispensing capsule is rod-shaped or elongated. For instance, the dispensing capsule can have a shell element having a continuous central space and at least two openings for the entry or exit of the drinking water. In this case, the dispenser substance may be provided in the central space. The dispensing capsule may have first and second closure means, which tightly close the openings in an initial configuration, wherein the closure means can be moved to an operational configuration, in which a flow path for drinking water through the shell member is opened. In this regard, the dispenser substance may be applied to or contained within at least one separate dispensing element disposed in the central space. Between the outer surface of the dispensing element and the inner surface of the envelope element, an intermediate area, through which the drinking water can permanently flow, can be formed and at least partially always remain free, i.e., there is permanently at least one continuously open flow channel between the two openings.

According to an advantageous embodiment, it is proposed that the mount forms an elongated space for the dispensing capsule. The space may have a round, in particular circular, or angular, for instance triangular, cross-section. The space or a cross-sectional shape of the space may be adapted, at least in sections, to a cross-sectional shape of the dispensing capsule.

According to a further advantageous embodiment, it is proposed that the mount comprises at least two holding devices for holding the dispensing capsule, which are arranged at opposite ends of the mount. In particular, the holding devices can each be formed for drinking water to flow therethrough. The holding devices can, for instance, each be pin-shaped, at least in sections. For instance, the holding devices may each have a tip that can help open the capsule (at either end).

According to a further advantageous embodiment, it is proposed that the dispenser cartridge forms a first water route extending through the mount and a second water route extending at least partially past the mount (in the manner of a bypass). The first water route can, for instance, be connectable to a carbonation device of the drinking-water dispensing system. The second water route can, for instance, be connectable to a mixed-water channel of the water faucet. The two water routes can be merged downstream of the dispenser cartridge, for instance in the area of a spray plate of the outlet element. The second water route may, for instance, at least partially encompass the first water route, such as being formed coaxially with the first water route.

According to a further advantageous embodiment, it is proposed that the dispenser cartridge comprises a bottom part and a top part, which are detachably interconnectable. In particular, the bottom part and the top part can be interconnected in a liquid-tight manner. The bottom part and the top part can, for instance, be screwed together. For instance, a section of one (lower or upper) part may be insertable into a corresponding section of the respective other (upper or lower) part. Connecting can be done, for instance, by moving the holding devices towards each other. This can contribute to opening the capsule (at both ends).

According to a further aspect, a drinking-water dispenser for discharging (on demand) at least partially carbonated drinking water is proposed, comprising a water faucet having an outlet element, from which the drinking water can be discharged and a base element, to which the outlet element can be connected, and a carbonating device that can be connected to the water faucet, further comprising a dispenser cartridge described herein, which can be detachably installed in the outlet element.

According to a further aspect, a method for tapping at least partially carbonated drinking water, into which a dispenser substance is introduced inside an outlet element of a drinking water tapping system is also proposed, comprising at least the steps outlined below:
a) installing a replaceable dispensing capsule in a mount of a dispenser cartridge for introducing the dispenser substance into the drinking water, such that the dispensing capsule is held in the mount such that at least a part of the drinking water flows through or around at least a part of the dispensing capsule,
b) installing the dispenser cartridge in the outlet element of the drinking-water dispenser,
c) carbonizing at least part of the drinking water, which is then discharged from the drinking-water dispenser through the outlet element,
d) introducing the dispenser substance into the drinking water by at least a part of the drinking water flowing through or around at least a part of the dispensing capsule arranged in the outlet element.

Steps a), b), c), and d) may be performed at least once in the specified order to perform the method. The dispenser cartridge and the dispensing capsule can also be detached or disassembled again if necessary, for instance to replace a used dispensing capsule or to use a dispensing capsule having a different dispenser substance. The method may, for instance, be performed using a dispenser cartridge described herein and/or using a drinking water dispenser described herein.

According to an advantageous embodiment, it is proposed that installing the interchangeable dispensing capsule comprises connecting a bottom part of the dispensing capsule to a top part of the dispensing capsule. Connecting can, for instance, (additionally) cause the dispensing capsule (in the dispenser cartridge) to open.

According to a further advantageous embodiment, it is proposed that carbonated drinking water flows at least through or around at least part of the dispensing capsule and is brought into contact with the dispenser substance in that way. This permits in an advantageous manner adding as much of the dispenser substance as desired to a drinking water that has been carbonated as much as possible. Furthermore, the drinking water to which the dispenser substance has been added and which has been carbonated in that way (for instance, in the first water route) can be mixed in the outlet element or upon or after leaving the outlet element with non-carbonated water which likewise flows (for instance, through the second water route) through the outlet element. For instance, mixing can take place in a spray plate or mixing chamber that is (directly) upstream of the spray plate of the outlet element.

For instance, (alternatively) a part of the drinking water that was carbonated (and that flowed through the second water route) and a separate part of the drinking water into which the dispenser substance was introduced by means of the dispensing cartridge (and that flowed through the first flow path) may be mixed together. This mixing can preferably take place in the outlet element or (still) inside the outlet element. For instance, mixing can take place in a spray plate or mixing chamber that is (directly) upstream of the spray plate of the outlet element.

According to a further aspect, a use of a dispenser cartridge installed in an outlet element of a drinking-water dispenser for introducing a dispenser substance into drinking water flowing through the outlet element while at least partially carbonated drinking water is discharged from the outlet element by the drinking-water dispenser is also proposed, wherein the dispenser cartridge has a mount for an exchangeable dispensing capsule comprising the dispenser substance and wherein the dispensing capsule is held in the mount in such a manner that at least a part of the drinking water flows through or around at least a part of the dispensing capsule. For instance, a dispenser cartridge described herein and/or a drinking water dispenser described herein may be used for this purpose.

The details, features and advantageous embodiments discussed in connection with the dispenser cartridge may accordingly also occur in the drinking water dispenser, method and/or use presented herein, and vice versa. In this respect, reference is made in full to the explanations given there for a more detailed characterization of the features.

The invention and its technical environment presented here are explained in more detail below with reference to the figures. It should be noted that the invention is not intended to be restricted by the shown exemplary embodiments. In particular, unless explicitly stated otherwise, it is also possible to extract partial aspects of the facts explained in or in the context of the Figures and combine them with other components and/or findings from other Figures and/or this description. In an exemplary and schematic manner

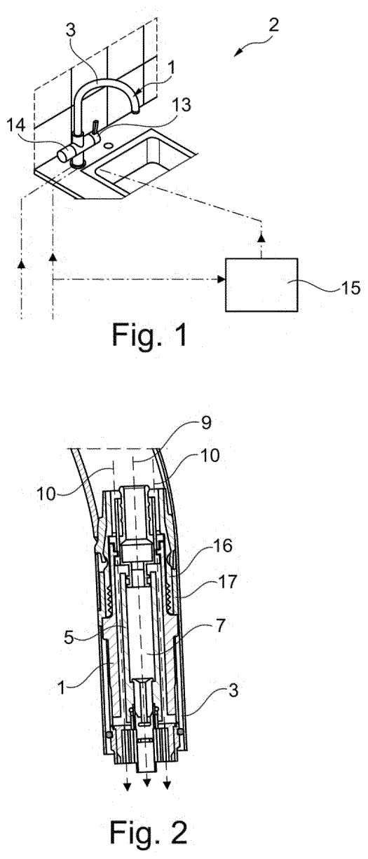

FIG. 1 shows a perspective view of a drinking-water dispenser described here,

FIG. 2 shows a detailed view of the outlet of a drinking-water dispenser described herein having a dispenser cartridge described herein in sectional view,

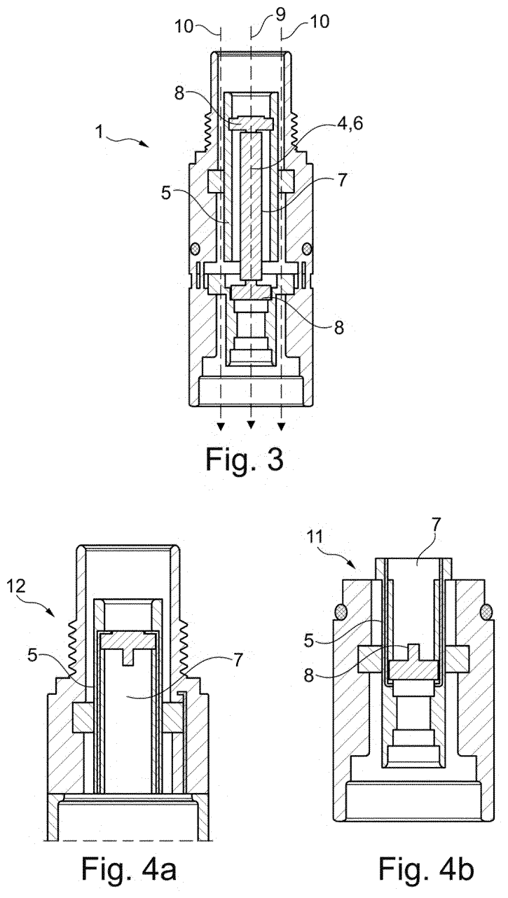

FIG. 3 shows a sectional view of a dispenser cartridge described here,

FIG. 4a shows a sectional view of a top part for a dispenser cartridge described herein, and

FIG. 4b shows a sectional view of a bottom part of a dispenser cartridge described here.

FIG. 1 shows an exemplary and schematic perspective view of a drinking water dispenser 2 described herein. The drinking water dispenser 2 is used to discharge at least partially carbonated drinking water. For this purpose, the drinking water dispenser 2 has a water faucet 13 and a carbonating device 15 connected to the water faucet 13. The water faucet 3 has an outlet element 3, from which the drinking water can be discharged, and a base element 14, to which the outlet element 3 is connected. Furthermore, the drinking-water dispenser 2 comprises a dispenser cartridge 1 described herein, which is detachably installed in the outlet element 3 of the water faucet 13.

The dashed lines in FIG. 1 indicate that, for instance, cold water can be supplied to both the water faucet 13 (directly) and the carbonating device 15. In addition, hot water can also be supplied (directly) to the water faucet 13 to be able to generate a mixed water having a desired temperature in the water faucet 13. By connecting the water faucet 13 and the carbonating device 15 to a cold-water supply, it can be advantageously achieved that carbonated or non-carbonated or differently carbonated (mixed) water of possibly even different temperatures can be dispensed by means of the drinking water dispenser 2 as required.

FIG. 2 shows in an exemplary and schematic manner a detailed view of the outlet 3 of a drinking-water dispenser 2 described here (cf. FIG. 1) having a dispenser cartridge 1 described here shown in sectional view. The dispenser cartridge 1 is provided and arranged for use in a drinking-water dispenser 2, by means of which at least partially carbonated drinking water can be discharged from an outlet element 3 of the drinking-water dispenser 2. The dispenser cartridge 1 is further provided and adapted for introducing a dispenser substance 4 into the drinking water. Furthermore, the dispenser cartridge 1 has a mount 5 for a replaceable dispensing capsule 6 comprising the dispenser substance 4 (cf. FIG. 3). The dispensing capsule 6 can be retained in the mount 5 such that at least some of the drinking water flows through or around at least a part of the dispensing capsule 6. Moreover, the dispenser cartridge 1 is arranged to be detachably installed (completely) in the outlet element 3 of the drinking-water dispenser 2.

FIG. 2 also shows that the dispenser cartridge 1 may form a first water route 9 extending through the mount 5 and a second water route 10 extending at least partially past the mount 5. Advantageously, this permits the introduction of the dispenser substance 4 into the drinking water to take place on an as-needed or optional basis, namely in particular when the first water route 9 is unblocked. To open the first water route 9, for instance, an end section of the outlet element 3 can be manually rotated. However, other options for the selective or on-demand introduction of the dispenser substance 4 are also conceivable, for instance, provision can be made for the first water route 9 to be only used or supplied with water when an introduction of the dispenser substance 4 is selected at the water faucet 13.

Furthermore, the water routes 9, 10 can also be separated from each other in such a way that carbonated drinking water can be conveyed via one of the water routes 9, 10 and non-carbonated drinking water can be conveyed via the other of the water routes 9, 10. Thus, the water routes 9, 10 can also contribute, if necessary, to a selectivity of the strength of carbonation, in particular via a mixing ratio of carbonated drinking water and non-carbonated drinking water can be adjusted or selected.

FIG. 2 further shows an example of how the dispenser cartridge 1 can be (re)detachably secured in the one outlet element 3. For instance, the dispenser cartridge 1 is provided with a (male) thread at one of its ends and that can be screwed into a sleeve 16, which is secured in the one outlet element 3. The sleeve 16 is also detachably secured in the outlet element 3 in this case by way of example. A holder 17, which can be formed of a spring-elastic material, for instance, contributes thereto.

FIG. 3 shows a sectional view of a dispenser cartridge 1 described here in an exemplary and schematic manner. The reference numerals are used uniformly to be able to make reference to the explanations above.

In FIG. 3, it can be seen that the mount 5 can form an elongated space 7 for the dispensing capsule 6. FIG. 3 further illustrates that the mount 5 may have at least two holding devices 8 for holding the dispensing capsule 6, arranged at opposite ends of the mount 5. Water may flow through the individual holding devices 8, such that water may flow into the dispenser cartridge 6 through one of the holding devices 8 (in this case, the upper holding device 8) and out of the dispensing capsule 6 through the other of the holding devices 8 (in this case, accordingly, the lower holding device 8). Furthermore, the holding devices 8 can contribute to the opening of the dispensing capsule 6. For instance, the holding devices 8 may each be pin-shaped and capable of piercing a closure of the dispensing capsule 6.

FIG. 4a shows a sectional view of a top part 12 for a dispenser cartridge 1 described here in an exemplary and schematic manner. In the top part 12, an upper part of the mount 5 is formed by way of example. Thus, for instance, an upper section of the space 7 and one of the holding devices 8 may also be formed in the top part 12.

FIG. 4b shows a sectional view of a bottom part 11 for a dispenser cartridge 1 described here in an exemplary and schematic manner. In the bottom part 11, a lower part of the mount 5 is formed by way of example. Thus, for instance, a lower section of the space 7 and one of the holding devices 8 may also be formed in the bottom part 11. Thus, FIGS. 4a and 4b illustrate an example of that and, if applicable, how the dispenser cartridge 1 may include a bottom part 11 and a top part 12 that can be detachably interconnected.

The drinking-water dispensing system 2 described herein, for instance, can be used to dispense at least partially carbonated drinking water, into which a dispenser substance 4 is introduced inside an outlet element 3 of the drinking-water dispensing system 2 in the manner outlined below.

First, the exchangeable dispensing capsule 6 can be installed in the mount 5 of the dispenser cartridge 1 for introducing the dispenser substance 4 into the drinking water. Installation is done in such a way that the dispensing capsule 6 is held in the mount 5 in such a way that at least a part of the drinking water flows through or around at least a part of the dispensing capsule 6. For instance, assembling the interchangeable dispensing capsule 6 may include connecting a bottom part 11 of the dispensing capsule 6 to a top part 12 of the dispensing capsule 6. Thereafter, the dispenser cartridge 1 can be installed in the outlet element 3 of the drinking-water dispenser 2.

Thereafter, at least a part of the drinking water can be carbonized, which may thereafter be discharged from the drinking-water dispenser 2 through the discharge element 3. After carbonization, the dispenser substance 4 can be introduced into the drinking water by at least a part of the dispenser cartridge 6 arranged in the outlet element 3 that is flowed through or around by at least a part of the drinking water. In this context, exemplary provision can be made for (previously) carbonated drinking water to flow at least through or around at least part of the dispenser cartridge 6 and thus be brought into contact with the dispenser substance 4. Alternatively, however, provision may be made for a part of the drinking water, which has been carbonated, and a separate (non-carbonated) part of the drinking water, into which the dispenser substance 4 has been introduced by means of the dispenser cartridge 1, to be mixed together, for instance in the outlet element 3.

On the basis of FIGS. 1 to 4, an advantageous way of using a dispenser cartridge 1 installed in an outlet element 3 of a drinking-water dispensing system 2 for introducing a dispenser substance 4 into drinking water flowing through the outlet element 3 while at least partially carbonated drinking water is discharged from the outlet element 3 by means of the drinking-water dispensing system 2 is also illustrated, wherein the dispenser cartridge 1 has a mount 5 for an exchangeable dispenser cartridge 6 comprising the dispenser substance 4, and wherein the dispenser cartridge 6 is held in the mount 5 in such a way that at least some of the drinking water flows through or around at least part of the dispenser cartridge 6.

Thus, a dispenser cartridge for a drinking-water dispensing system, a drinking-water dispensing system having such a dispenser cartridge, a method for dispensing at least partially carbonated drinking water, in which a dispenser substance is introduced inside an outlet element of a drinking-water dispensing system, and a use of a dispenser cartridge installed in an outlet element of a drinking-water dispensing system are disclosed, which at least partially solve the problems described with reference to the prior art. In particular, this enables a user to design a beverage as individually as possible and at the same time to produce this beverage as quickly as possible and in as large a quantity as required.

### LIST OF REFERENCE NUMERALS

1 dispenser cartridge

2 drinking-water tap

3 outlet element

4 dispenser substance

5 mount

6 dispenser cartridge

7 space

8 holding device

9 first water route

10 second water route

11 bottom part

12 top part

13 water faucet

14 base element

15 carbonizer

16 sleeve

17 holder

1. A dispenser cartridge (1) for a drinking-water dispensing system (2), by means of which at least partially carbonated drinking water can be dispensed from an outlet element (3) of the drinking-water dispensing system (2), contributes to solving the problem, wherein the dispenser cartridge (1) is provided and set up for introducing a dispenser substance (4) into the drinking water, wherein the dispensing cartridge (1) comprises a mount (5) for an exchangeable dispensing cartridge (6) comprising the dispenser substance (4), wherein the dispensing cartridge (6) can be held in the mount (5) in such a manner that at least a part of the drinking water flows through or around at least a part of the dispensing cartridge (6), and wherein the dispensing cartridge (1) is set up in such a manner that it can be detachably installed in the outlet element (3) of the drinking-water dispensing system (2).

2. The dispenser cartridge (1) according to claim 1, wherein the mount (5) forms an elongated space (7) for the dispenser cartridge (6).

3. The dispenser cartridge (1) according to claim 1, wherein the mount (5) comprises at least two holding devices (8) for holding the dispenser cartridge (6), which holding devices are arranged at opposite ends of the mount (5).

4. The dispenser cartridge (1) according to claim 1, wherein the dispenser cartridge (1) forms a first water route (9) extending through the mount (5) and a second water route (10) extending at least partially past the mount (5).

5. The dispenser cartridge (1) according to claim 1, wherein the dispenser cartridge (1) comprises a bottom part (11) and a top part (12) that can be detachably interconnected.

6. A drinking-water dispenser (2) for discharging at least partially carbonated drinking water, comprising a water faucet (13) having an outlet element (3), from which the drinking water can be discharged, and a base element (14) to which the outlet element (3) can be connected, and a carbonating device (15) that can be connected to the water faucet (13), further comprising a dispenser cartridge (1) according to claim 1, which is detachably installed in the outlet element (3).

7. A method of dispensing at least partially carbonated drinking water into which a dispenser substance (4) is introduced inside an outlet element (3) of a drinking water tap (2), comprising at least the following steps:
a) installing a replaceable dispensing capsule (6) in a mount (5) of a dispenser cartridge (1) for introducing the dispenser substance (4) into the drinking water, such that the dispensing capsule (6) is held in the mount (5) such that at least a part of the drinking water flows through or around at least a part of the dispensing capsule (6),
b) installing the dispenser cartridge (1) in the outlet element (3) of the drinking-water dispenser (2),
c) carbonizing at least part of the drinking water, which is then discharged from the drinking-water dispenser (2) through the outlet element (3),
d) introducing the dispenser substance (4) into the drinking water by at least a part of the drinking water flowing through or around at least a part of the dispensing capsule (6) arranged in the outlet element (3).

8. The method of claim 7, wherein assembling the replaceable dispenser cartridge (6) comprises connecting a bottom part (11) of the dispensing capsule (6) to a top part (12) of the dispensing capsule (6).

9. The method of claim 7, wherein carbonated drinking water flows through or around at least a part of the dispensing capsule (6) and is thus brought into contact with the dispenser substance (4).

10. Use of a dispenser cartridge (1) installed in an outlet element (3) of a drinking- water dispensing system (2) for introducing a dispenser substance (4) into drinking water flowing through the outlet element (3) while at least partially carbonated drinking water is discharged from the outlet element (3) by means of the drinking-water dispensing system (2), wherein the dispenser cartridge (1) has a mount (5) for an exchangeable dispensing capsule (6) comprising the dispenser substance (4), and wherein the dispensing capsule (6) is held in the mount (5) in such a way that at least some of the drinking water flows through or around at least part of the dispensing capsule (6).
